(19) United States
(12) Patent Application Publication
(10) Pub. No.: US 2026/0105368 A1
(43) Pub. Date: Apr. 16, 2026

(54) COMPUTATIONAL STORAGE DEVICE AND COMPUTING SYSTEM

(71) Applicant: SK hynix Inc., Gyeonggi-do (KR)

(72) Inventors: Jongryool KIM, San Jose, CA (US); Kevin TANG, San Jose, CA (US); Younghoon MIN, San Jose, CA (US); Timothy LO, San Jose, CA (US); Myoung Seo KIM, Gyeonggi-do (KR); Ho Shik KIM, Gyeonggi-do (KR)

(21) Appl. No.: 19/310,952

(22) Filed: Aug. 27, 2025

(30) Foreign Application Priority Data
Oct. 14, 2024 (US) 63706919

(51) Int. Cl. G06N 20/00

(52) U.S. Cl. CPC G06N 20/00

(57) ABSTRACT

Embodiments of the present disclosure may perform some of computations for training of an artificial intelligence model in a storage device located outside a training device, thereby reducing the computation load of the training device, and may reduce the amount of data moved between the training device and the storage device in the process of performing training, thereby improving the operational performance of a computing system that performs training.

### CROSS-REFERENCE TO RELATED APPLICATIONS

The present application claims priority and benefits of U.S. Patent Application No. 63/706,919, filed on Oct. 14, 2024, which is incorporated herein by reference in its entirety.

### BACKGROUND

### 1. Technical Field

Embodiments of the present disclosure relate to a computational storage device and a computing system.

### 2. Related Art

With the recent rapid development of artificial intelligence technology, various machine learning methods, including deep learning, are being applied to various fields such as speech recognition, image analysis and natural language processing. These artificial intelligence models have numerous parameters and complex computational structures, and hardware capable of performing large-scale computations in parallel is required to efficiently train the artificial intelligence models.

Meanwhile, various performance degradation factors such as memory bottlenecks, inefficient use of computational resources and increased data movement costs are occurring due to the increase in the size of artificial intelligence models, the expansion of learning data and the diversification of computational patterns. In particular, because repeated updates of model parameters and large-scale matrix computations are performed during a learning phase, measures capable of increasing computational efficiency and minimizing resource waste are required.

### SUMMARY

Objects of embodiments of the disclosure are not limited to those set forth herein, and other unmentioned objects would be apparent to one of ordinary skill in the art from the following description.

Embodiments of the present disclosure are directed to providing a processing system and an architecture capable of improving the efficiency of computations performed for learning or training of an artificial intelligence model and the efficiency of data movement.

In an embodiment, a computing system may include: a first processing unit configured to perform training computations based on first model parameters to generate training data; and a computational storage device configured to receive the training data from the first processing unit, perform second optimization computations based on the first model parameters, the training data and first optimization variables, the first optimization variables being generated by first optimization computations for generating the first model parameters, and provide second model parameters generated by the second optimization computations to the first processing unit.

In an embodiment, a computing system may include: a first processing unit configured to perform training computations using first model parameters to generate training data; and a second processing unit configured to perform optimization computations based on the training data, provide second model parameters generated by the optimization computations to the first processing unit, and store at least some of the training data and the second model parameters.

In an embodiment, a computational storage device may include: a memory configured to store first model parameters and first optimization variables; and a controller configured to provide the first model parameters to an external device, receive training data generated by training computations performed by the external device based on the first model parameters, perform optimization computations based on the first model parameters, the training data and the first optimization variables, and provide second model parameters generated by the optimization computations to the external device.

According to embodiments of the present disclosure, it is possible to provide a system capable of improving the performance of learning, training, etc. of an artificial intelligence model, by improving the efficiencies of computations performed for learning, training, etc. of the artificial intelligence model and data movement occurring according to the computations.

The effects of the disclosure are not limited to the foregoing objects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 is a diagram illustrating an example of the schematic configuration of a computing system according to embodiments of the present disclosure.

FIG. 2 is a diagram illustrating an example of a schematic operation performed by the computing system according to the embodiments of the present disclosure for training of an artificial intelligence model.

FIG. 3 is a diagram illustrating a schematic example of a checkpoint operation performed by the computing system according to the embodiments of the present disclosure in the process of progressing training of an artificial intelligence model.

FIG. 4 and FIG. 5 are diagrams illustrating other examples of the schematic operation performed by the computing system according to the embodiments of the present disclosure for training of an artificial intelligence model.

FIG. 6 is a diagram illustrating an example of a detailed operation performed by the computing system according to the embodiments of the present disclosure for training of an artificial intelligence model.

FIG. 7 is a diagram illustrating another example of the detailed operation performed by the computing system according to the embodiments of the present disclosure for training of an artificial intelligence model.

FIG. 8 is a diagram illustrating an example of comparing operations and data movements performed according to methods in which the computing system according to the embodiments of the present disclosure progresses training of an artificial intelligence model.

FIG. 9 is a diagram illustrating examples of data stored in a storage device and a restoration operation using the same according to a checkpoint operation performed by the computing system according to the embodiments of the present disclosure in the process of progressing training of an artificial intelligence model.

FIG. 10 is a diagram illustrating another example of the schematic structure of the computing system according to the embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc., a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc., each other via a fourth element. Here, the second element may be included in at least one of two or more elements that “are connected or coupled to”, “contact or overlap”, etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompass all the meanings of the term “can.” Hereinafter, various embodiments of the present disclosure will be described in detail with reference to accompanying drawings.

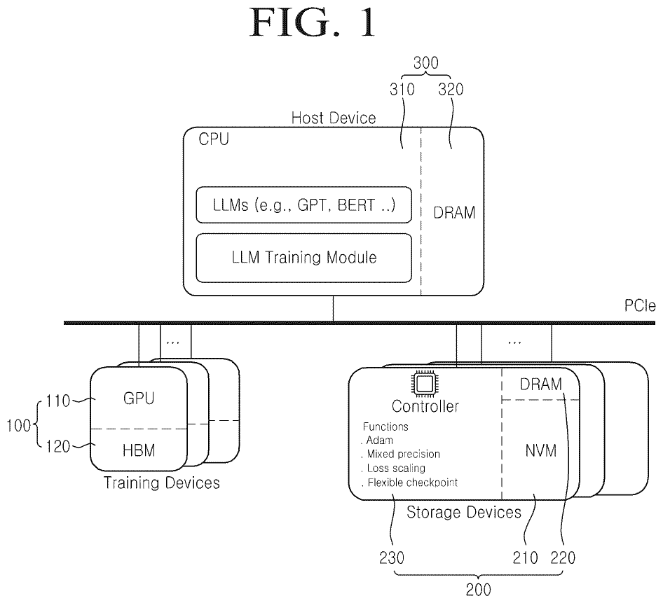

FIG. 1 is a diagram illustrating an example of the schematic configuration of a computing system according to embodiments of the present disclosure.

Referring to FIG. 1, the computing system according to the embodiments of the present disclosure may include at least one processing device. The processing device may mean a device that performs computations for data processing. The computing system may include at least one device that stores data. The type of the device that stores data may be various types of data storage devices.

For example, the computing system may include at least one training device 100. In the present specification, the training device 100 may be referred to as a first processing unit.

The training device 100 may include, for example, a first processor 110 and a first processing memory 120. The training device 100 may be a device that performs computations for learning or training of an artificial intelligence model.

The training device 100 may include a processor and memory suitable for computations for learning or training of an artificial intelligence model. For example, the first processor 110 may be a graphics processing unit (GPU), but is not limited thereto. The first processing memory 120 may be a high bandwidth memory (HBM), but is not limited thereto. In particular embodiments, the first processing memory 120 may include a memory such as Graphics Double Data Rate (GDDR).

The computing system may include at least one storage device 200. The storage device 200 included in the computing system may provide a computational function. In the present specification, the storage device 200 may be referred to as (and/or include) a computational storage device.

The storage device 200 may include, for example, a first memory 210, a second memory 220 and a controller 230.

The first memory 210 may be, for example, a nonvolatile memory such as a NAND flash memory, but is not limited thereto. The second memory 220 may be, for example, a volatile memory such as a dynamic random-access memory (DRAM), but is not limited thereto. The second memory 220 may be used to store data required when controlling the operation of the first memory 210.

The controller 230 may control the first memory 210 and the second memory 220. The controller 230 may control the operations of the first memory 210 and the second memory 220 on the basis of a command received from the outside or an internal command. The controller 230 may store necessary data using the second memory 220 in the process of storing data in the first memory 210 or reading data stored in the first memory 210.

The controller 230 may provide a computational function in addition to the function of controlling the first memory 210 and the second memory 220. The controller 230 may perform computational functions based on Adam, mixed precision, loss scaling, flexible checkpoint, etc. The computational function provided by the controller 230 may be at least a part of a computational function performed by the first processor 110 of the training device 100. Alternatively, the computational function provided by the controller 230 may be a function different from a computational function performed by the first processor 110 of the training device 100.

While transmitting and receiving data to and from the training device 100, the controller 230 may perform computations based on data received from the training device 100. The controller 230 may provide at least some of result data according to the performed computations to the training device 100. The controller 230 and the training device 100 may communicate on the basis of Peripheral Component Interconnect Express (PCIe), but are not limited thereto.

The computing system may further include a host device 300. In accordance with embodiments of the present disclosure, the training device 100 may also perform the function of the host device 300. Alternatively, as in the example illustrated in FIG. 1, the host device 300 may be included in the computing system in addition to the training device 100. In the present specification, the host device 300 may be referred to as a second processing unit.

The host device 300 may include, for example, a second processor 310 and a second processing memory 320. The host device 300 may control the operations of the training device 100 and the storage device 200. While controlling the training device 100 and the storage device 200, the host device 300 may control learning or training of an artificial intelligence model. In addition, the host device 300 may control inference using an artificial intelligence model.

The host device 300 controls the training device 100 and the storage device 200, and may include a processor and a memory suitable for processing using an artificial intelligence model.

For example, the second processor 310 included in the host device 300 may be a central processing unit (CPU), but is not limited thereto. The second processing memory 320 may be a DRAM, but is not limited thereto. The second processor 310 may control an operation such as learning, training and inference based on a large language model such as Generative Pre-trained Transformer (GPT). The second processor 310 may include large language models (LLMs), such as GPT, BERT, etc. The second processor 310 may include an LLM training module.

Under the control of the host device 300, training of an artificial intelligence model using the training device 100 and the storage device 200 may be performed. In the process of training an artificial intelligence model, computations by the training device 100 or the storage device 200 may be performed. Data may be transmitted and received between the training device 100 and the storage device 200.

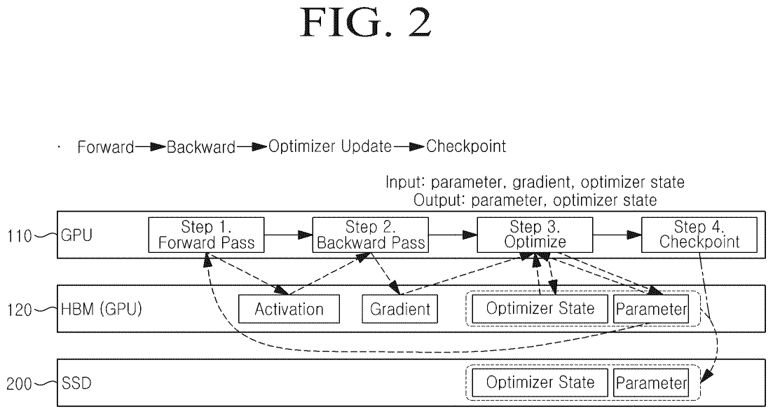

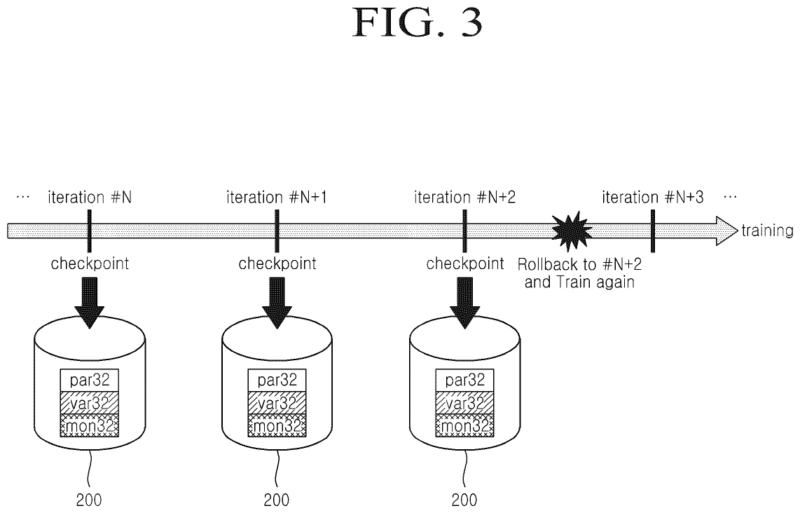

FIG. 2 is a diagram illustrating an example of a schematic operation performed by the computing system according to the embodiments of the present disclosure for training of an artificial intelligence model. FIG. 3 is a diagram illustrating a schematic example of a checkpoint operation performed by the computing system according to the embodiments of the present disclosure in the process of progressing training of an artificial intelligence model as in the example illustrated in FIG. 2.

Referring to FIG. 2, under the control of the host device 300, training of an artificial intelligence model by the training device 100 and the storage device 200 may be performed. In accordance with embodiments of the present disclosure, when the training device 100 provides the function of the host device 300, training of an artificial intelligence model may be performed under the control of the training device 100.

Training of an artificial intelligence model may include, for example, forward training computations, backward training computations, optimization computations, etc. Training of an artificial intelligence model may mean a process of updating model parameters obtained or generated through learning of the artificial intelligence model. By updating the model parameters through the training, the performance of the artificial intelligence model based on the model parameters may be improved.

Computations for training of an artificial intelligence model may be performed in each of a plurality of layers included in the artificial intelligence model. Computations may be performed in a forward direction or backward direction in each layer, and training data according to the computations may be provided. An operation of updating model parameters using training data and model parameters obtained or generated through previous training may be performed.

Each computation included in training may be performed, for example, by the training device 100. Data generated through the training by the training device 100 may be stored in a memory included in the training device 100 or in a memory included in the storage device 200.

For example, forward training computations (Forward Pass) may be performed by the first processor 110 of the training device 100.

The forward training computations may be performed using model parameters generated by previously performed training. The model parameters generated by the previously performed training may be provided by being stored in the first processing memory 120 of the training device 100. Alternatively, in some cases, the model parameters may be provided by being stored in the storage device 200.

Active data (Activation) may be generated by the forward training computations of the first processor 110. The active data may be stored in the first processing memory 120.

The first processor 110 may perform backward training computations (Backward Pass) using the model parameters and the active data. Training data (Gradient) may be generated by the backward training computations. The training data may be stored in the first processing memory 120.

The first processor 110 may perform optimization computations (Optimize or Optimizer Update) using the model parameters and the training data. The optimization computations may mean computations that update the model parameters on the basis of the training data. Optimization variables (Optimizer State) may be generated through the optimization computations. The optimization variables may include momentum (or moment), variance, etc. regarding the model parameters.

When an update of the optimization variables and the model parameters is completed through training, the first processor 110 may perform training again on the basis of the updated data. The first processor 110 may perform forward training computations, backward training computations and optimization computations using the updated data. The first processor 110 may repeatedly perform training while updating model parameters.

In the process of performing training, the first processor 110 may perform a checkpoint operation of storing updated model parameters, etc. The first processor 110 may perform an operation of storing optimization variables and model parameters generated or updated through training in a device located outside the training device 100.

For example, the first processor 110 may periodically perform a checkpoint operation of storing optimization variables and model parameters in the storage device 200. When optimization variables and model parameters are generated or updated through forward training computations, backward training computations and optimization computations, the first processor 110 may store the optimization variables and the model parameters in the storage device 200. The checkpoint operation may be performed simultaneously with an operation in which the first processor 110 performs next training, or next training may be performed after the checkpoint operation is completed.

The first processor 110 may store optimization variables and model parameters in the storage device 200 through a checkpoint operation, and when previously generated optimization variables and model parameters are needed in a subsequent training process, may obtain the corresponding data through the storage device 200.

For example, referring to FIG. 3, an example is illustrated, in which the training device 100 performs a checkpoint operation in the process of repeatedly performing training.

The training device 100 may perform #Nth training and store optimization variables var32 and mon32 generated through the corresponding training in the storage device 200. The training device 100 may store model parameters par32 generated through the corresponding training in the storage device 200. The training device 100 may store at least some of optimization variables and model parameters generated through corresponding training in the storage device 200 through a checkpoint operation.

Similarly, after performing #(N+1)th training and #(N+2)th training, the training device 100 may store optimization variables and model parameters generated through the corresponding training in the storage device 200. FIG. 3 illustrates a case where a checkpoint operation is performed every time training is performed, but in some cases, a checkpoint operation may be performed after a predetermined number of training times, for example, every two or at least three training times.

Through the checkpoint operation, optimization variables and model parameters generated through each training may be stored in the storage device 200. In the process of subsequently performing training, a system or program error may occur.

In such instances, data being generated through the corresponding training may be invalid. It may be necessary to recover (or restore) model parameters used for the training by using optimization variables and model parameters generated through previous training. For example, when an error occurs in the process of performing #(N+3)th training, the training device 100 may perform the #(N+3)th training again using the optimization variables and the model parameters according to the #(N+2)th training stored in the storage device 200. When data according to the #(N+2)th training is invalid or does not exist, training may be performed again using the optimization variables and the model parameters according to the #(N+1)th training.

Because a checkpoint operation is performed periodically, even when an error occurs during a plurality of training processes of the training device 100, recent data may be restored using data stored through the checkpoint operation, and training may be performed again using the restored data.

In this way, even when an error occurs during training of an artificial intelligence model, decrease in the efficiency of training may be prevented or reduced by a checkpoint operation. In addition, as the case may be, by causing a checkpoint operation to be performed in the storage device 200, the checkpoint operation may be performed while increasing the efficiency of data movement between the training device 100 and the storage device 200. In such a case, at least some of computational operations for training may be performed by the storage device 200.

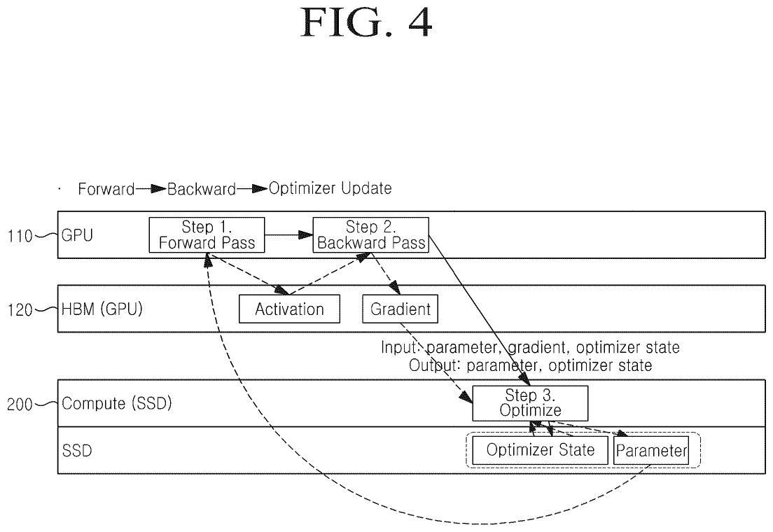

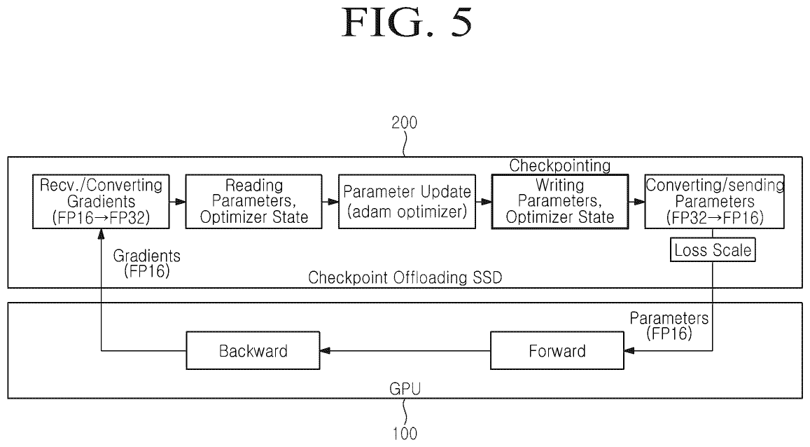

FIG. 4 and FIG. 5 are diagrams illustrating other examples of the schematic operation performed by the computing system according to the embodiments of the present disclosure for training of an artificial intelligence model.

Referring to FIG. 4, at least some of computations for training may be performed by the first processor 110 of the training device 100.

For example, the first processor 110 may perform forward training computations. The first processor 110 may perform the forward training computations using model parameters obtained or generated by previously performed training. The first processor 110 may be provided with the model parameters according to the previous training from the storage device 200.

The first processor 110 may generate active data through the forward training computations (e.g., step 1., forward pass). The first processor 110 may store the active data in the first processing memory 120. The first processor 110 may perform backward training computations using the previously generated model parameters and the active data (e.g., step 2., backward pass). The first processor 110 may generate training data through the backward training computations. The first processor 110 may provide the generated training data to the storage device 200 located outside the training device 100.

The storage device 200 may perform optimization computations on the basis of the training data received from the training device 100. The storage device 200 may perform the optimization computations using optimization variables generated by previously performed optimization computations, the received training data and model parameters generated by previously performed training. The storage device 200 may generate or update optimization variables and model parameters through the optimization computations.

The storage device 200 may provide the model parameters generated through the optimization computations to the training device 100. New training by the training device 100 may be performed on the basis of the model parameters provided by the storage device 200.

The storage device 200 may store at least some of the optimization variables and the model parameters generated through the optimization computations. Because the optimization computations are performed in the storage device 200, data movement for storing the optimization variables and the model parameters according to the optimization computations may not occur.

Because forward training computations and backward training computations among computations for training of an artificial intelligence model are performed by the first processor 110, training performance may be maintained. Because only training data generated according to backward training computations is moved to the storage device 200, the amount of data transmitted from the training device 100 to the storage device 200 may be reduced.

In addition, because optimization variables and model parameters according to optimization computations are stored in the storage device 200 where the optimization computations are performed, storage of data generated or updated by the optimization computations may be made easier. Data movement for storing training data, model parameters, etc., for restoration in the storage device 200 may be unnecessary or reduced.

The efficiency of computations and data movement for training of an artificial intelligence model using the training device 100 and the storage device 200 may be improved.

In addition, by setting the types of data differently, such as model parameters managed in the training device 100 and data such as model parameters managed in the storage device 200, the efficiency of training of an artificial intelligence model performed using the training device 100 and the storage device 200 may be further increased.

For example, referring to FIG. 5, a case where only forward training computations and backward training computations are performed in the training device 100 is illustrated. The training device 100 may perform forward training computations by receiving model parameters from the storage device 200. The training device 100 may provide training data generated by performing backward training computations to the storage device 200.

Model parameters received by the training device 100 from the storage device 200 may be data according to a first unit data size FP16.

A unit data size may mean, for example, the number of bits that make up each data. The training data transmitted from the training device 100 to the storage device 200 may be data according to the first unit data size. Data processed in the training device 100 and transmitted and received by the training device 100 may be data according to the first unit data size.

When receiving the training data according to the first unit data size from the training device 100, the storage device 200 may convert the training data into data according to a second unit data size FP32. The second unit data size may be larger than the first unit data size. For example, the storage device 200 may be implemented as a checkpoint offloading solid state drive (SSD) that receives and/or converts gradients FP16 to FP32.

The storage device 200 may perform optimization computations using the training data converted into the second unit data size. In the checkpointing, the storage device 200 may read parameters, and optimizer state. The storage device 200 may read optimization variables and model parameters according to previously performed optimization computations and may perform optimization computations based on the converted training data, thereby updating the model parameters. The optimization computations may be performed by, for example, the Adam optimizer, but are not limited thereto.

The storage device 200 may store optimization variables and model parameters generated or updated by the optimization computations. A checkpoint operation may be performed while storing the optimization variables and the model parameters.

The storage device 200 may perform the checkpoint operation, and may convert model parameters according to the second unit data size into the first unit data size (for example, FP32 to FP16). The model parameters converted into the first unit data size smaller than the second unit data size may be provided to the training device 100 (for example, loss scale). The training device 100 may perform new training using the model parameters according to the first unit data size.

By setting the size of data to be used in computations to be performed by the training device 100 small, the data storage load of the training device 100 may be reduced. In addition, the size of data to be moved between the training device 100 and the storage device 200 may be reduced.

Because the storage device 200 performs optimization computations by converting data into the second unit data size larger than the first unit data size and stores data, the performance of optimization computations may be improved, and training data, optimization variables, model parameters, etc., may be managed more efficiently.

In this way, the operational performance of the computing system that performs training of an artificial intelligence model may be improved while performing at least some of computations for training by the storage device 200. In addition, in particular implementations, a device other than the training device 100 that performs at least some of computations for training may be selected from various types of computing devices.

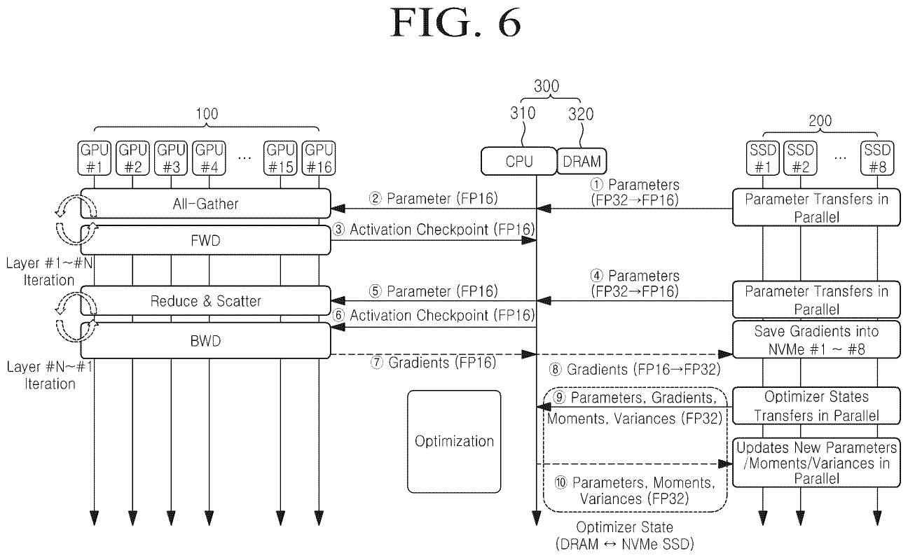

FIG. 6 is a diagram illustrating an example of a detailed operation performed by the computing system according to the embodiments of the present disclosure for training of an artificial intelligence model.

Referring to FIG. 6, an example of a process in which computations for training of an artificial intelligence model are performed by the computing system is illustrated. The computing system may include a plurality of training devices 100 and a plurality of storage devices 200, and may include a host device 300 that controls the training devices 100 and the storage devices 200.

Some of computations for training may be performed by the training device 100 (for example, implementing GPUs 1 to 16, as shown in FIG. 6), and the other some may be performed by devices other than the training devices 100. For example, some of the computations for training may be performed by the host device 300. A checkpoint operation may be performed while computations for training are performed by the training device 100 and the host device 300.

Describing sequentially processes in which computations for training are performed, as in \textcircled{1}, model parameters stored in the storage device 200 may be provided to the host device 300. The model parameters provided from the storage device 200 may be model parameters that are generated or updated by previously performed training. For example, the process may include parameter transfers in parallel from SSDs 1 to 8 of the storage device 200.

The storage device 200 may convert the model parameters according to the second unit data size into the first unit data size (for example, FP32 to FP16) and provide the converted model parameters to the host device 300.

As in \textcircled{2}, the host device 300 may provide the model parameters converted into the first unit data size to the training device 100. The training device 100 may collect the model parameters and perform forward training computations (for example, all-gather and forward training (FWD), layer 1 to N iteration). The training device 100 may generate active data through the forward training computations. As in \textcircled{3}, the training device 100 may transmit the active data to the host device 300 and store the active data in the host device 300 (for example, activation checkpoint).

As in \textcircled{4}, the storage device 200 may provide model parameters converted from the second unit data size into the first unit data size to the host device 300. As in \textcircled{5}, the host device 300 may provide the model parameters according to the first unit data size to the training device 100. As in \textcircled{6}, the training devices 100 may receive the active data stored in the host device 300 through a checkpoint operation (for example, activation checkpoint).

The training device 100 may perform backward training computations using the model parameters and the active data (for example, reduce and scatter and backward training (BWD), layer N to 1 iteration). As in \textcircled{7}, the training device 100 may provide training data (for example, gradients (FP16)) generated by the backward training computations to the host device 300. The training data transmitted to the host device 300 may be data according to the first unit data size.

As in \textcircled{8}, the host device 300 may transmit the training data to the storage device 200. The host device 300 may convert the training data set to the first unit data size into the second unit data size (for example, FP16 to FP32) and provide the converted training data to the storage device 200. In some cases, the storage device 200 may receive the training data of the first unit data size and convert the training data into the second unit data size. The training data may be stored in the storage device 200. The storage device 200 may save gradients into non-volatile memory (for example, NVMe 1 to 8).

As in \textcircled{9}, the storage device 200 may provide optimization variables and model parameters according to previously performed optimization computations, training data, etc., to the host device 300 (for example, parameters, gradients, moment, variances (FP32)). The storage device 200 may provide only the function of storing model parameters, optimization variables, training data, etc. The host device 300 may perform optimization computations on the basis of data received from the storage device 200.

As in \textcircled{10}, the host device 300 may provide model parameters and optimization variables, etc., generated or updated by the optimization computations to the storage device 200. Because the optimization computations are performed by the host device 300, the computation operation load of the training device 100 may be reduced.

In this way, optimization computations may be performed by the host device 300. However, by performing optimization computations by the storage device 200, training may be performed while reducing the amount of data transmitted and received between the storage device 200 and a device located at the outside.

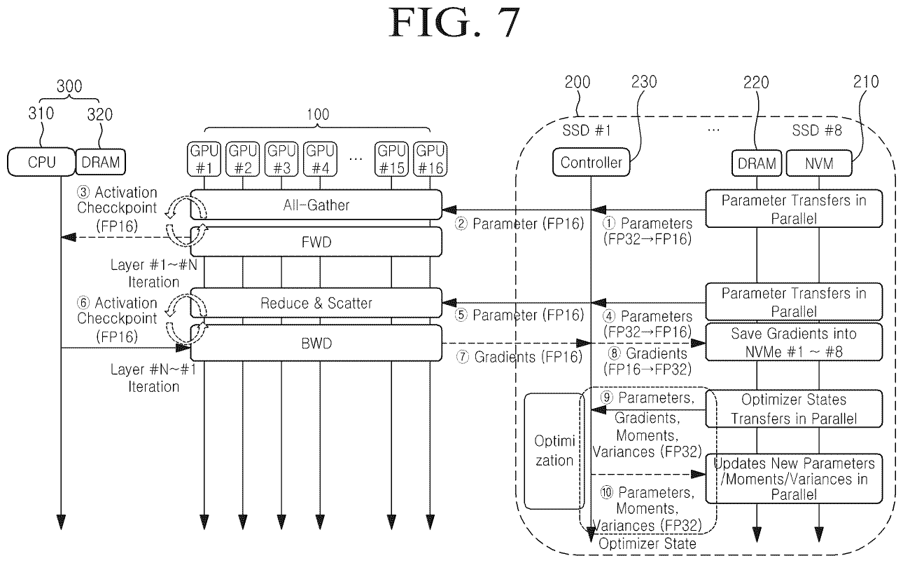

FIG. 7 is a diagram illustrating another example of the detailed operation performed by the computing system according to the embodiments of the present disclosure for training of an artificial intelligence model.

Referring to FIG. 7, computations for training may be performed by the training device 100. As in \textcircled{1}, the controller 230 of the storage device 200 may convert model parameters according to the second unit data size into the first unit data size. As in \textcircled{2}, the controller 230 may provide the model parameters of the first unit data size to the training device 100.

The training device 100 may perform forward training computations using the model parameters. As in \textcircled{3}, the training device 100 may store active data generated by the forward training computations in the host device 300. The active data may be data according to the first unit data size.

As in \textcircled{4}, the storage device 200 may convert model parameters of the second unit data size into the first unit data size, and as in \textcircled{5}, may provide model parameters according to the first unit data size to the training device 100.

As in \textcircled{6}, the training device(s) 100 may receive the active data from the host device 300. The training devices 100 may perform backward training computations using the model parameters and the active data.

As in \textcircled{7}, the training device 100 may provide training data generated by the backward training computations to the storage device 200. The training data provided by the training device 100 may be data according to the first unit data size.

As in \textcircled{8}, the storage device 200 may convert the training data in accordance with the first unit data size to conform to the second unit data size. As in \textcircled{9}, the controller 230 of the storage device 200 may read model parameters, training data and optimization variables according to the second unit data size. The controller 230 may perform optimization computations using the read data.

As in \textcircled{10}, the controller 230 may store model parameters, optimization variables, etc., generated by performing the optimization computations in the first memory 210 or the second memory 220. Because a checkpoint operation is performed while the optimization computations are performed inside the storage device 200, the amount of data to be moved between the storage device 200 and the training device 100 may be reduced. The efficiency of data movement according to computations for training may be improved.

The efficiency of data movement according to the checkpoint operation may be improved, and the efficiency of data movement performed when performing restoration using data stored according to the checkpoint operation may also be improved.

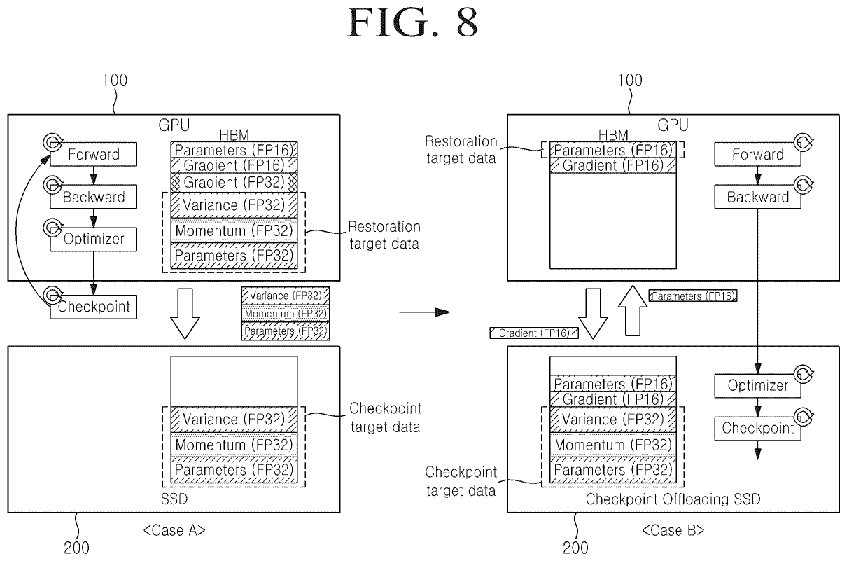

FIG. 8 is a diagram illustrating an example of comparing operations and data movements performed according to methods in which the computing system according to the embodiments of the present disclosure progresses training of an artificial intelligence model.

Referring to FIG. 8, <Case A> represents a case where all computations for training of an artificial intelligence model are performed in the training device 100, and <Case B> represents a case where some of computations for training of an artificial intelligence model are performed outside the training device 100.

As in <Case A>, forward training computations, backward training computations and optimization computations may be performed in the training device 100. The training device 100 may perform the backward training computations using model parameters set to the first unit data size and generate training data set to the first unit data size. The training device 100 may convert the training data set to the first unit data size to conform to the second unit data size. The training device 100 may perform the optimization computations using the training data set to the second unit data size, and may generate optimization variables and model parameters set to the second unit data size (for example, restoration target data).

The training device 100 may store the optimization variables and the model parameters set to the second unit data size in the storage device 200 through a checkpoint operation (for example, checkpoint offloading with checkpoint target data).

In the case of <Case B>, the training device 100 may perform only forward training computations and backward training computations. The training device 100 may receive model parameters set to the first unit data size, and may generate training data set to the first unit data size according to computations for training. When the training data is generated, the training device 100 may transmit the generated training data to the storage device 200. Data stored in the training device 100 may be the model parameters and the training data according to the first unit data size. The computation load and data storage area of the training device 100 may be reduced.

The storage device 200 may perform optimization computations using the training data according to the first unit data size received from the training device 100. The storage device 200 may convert the training data according to the first unit data size into the second unit data size.

The storage device 200 may perform optimization computations using the training data set to the second unit data size, and may store optimization variables and model parameters generated by the optimization computations. The optimization variables and the model parameters may be data set according to the second unit data size.

The storage device 200 may store the data generated according to the optimization computations, and may provide the model parameters generated according to the optimization computations to the training device 100. The model parameters provided to the training device 100 may be used for computations for next training. The storage device 200 may convert the model parameters according to the second unit data size into the first unit data size and provide the converted model parameters to the training device 100.

The storage device 200 may provide the model parameters converted into the first unit data size to the training device 100, and may store at least some of the model parameters, the optimization variables and the training data.

The storage device 200 may store and maintain data by a checkpoint operation, and, when a restoration request is received from the training device 100, may provide the stored data to the training device 100.

The storage device 200 may store all data according to the checkpoint operation or store only some of data, and may provide restored data or provide data as it is according to a request from the training device 100.

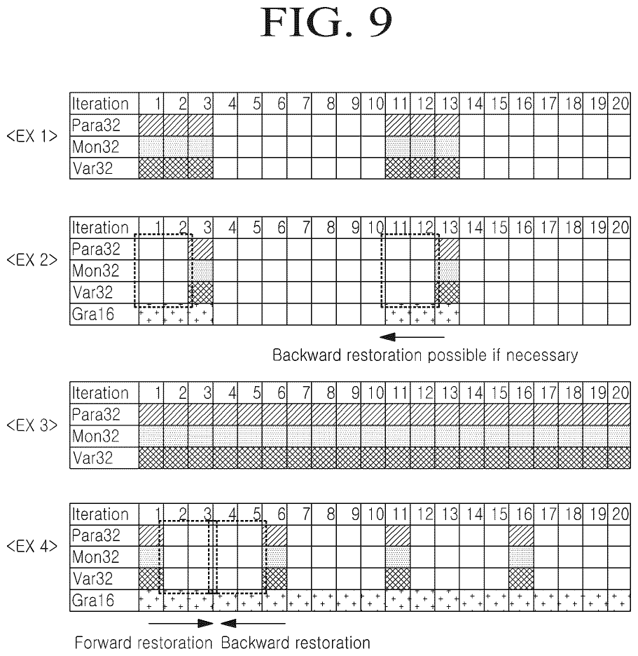

FIG. 9 is a diagram illustrating examples of data stored in a storage device and a restoration operation using the same according to a checkpoint operation performed by the computing system according to the embodiments of the present disclosure in the process of progressing learning of an artificial intelligence model.

Referring to FIG. 9, examples of data stored in the storage device 200 by a checkpoint operation at each time point when training is performed by the training device 100 are illustrated.

The training device 100 may provide training data by performing forward training computations and backward training computations. The training data set according to the first unit data size may be referred to as Gra16.

The storage device 200 may generate or update optimization variables and model parameters by performing optimization computations using received training data. The optimization variables and the model parameters generated by the optimization computations may be set according to the second unit data size. The optimization variables may be Mon32 and Var32, and the model parameters may be Para32.

As in <EX 1> or <EX 2>, only data of some training time points among respective training time points may be stored in the storage device 200 according to a checkpoint operation.

For example, as in the example illustrated in <EX 1>, only optimization variables and model parameters generated at training time points 1, 2, 3, 11, 12 and 13 may be stored in the storage device 200. When a restoration request by the training device 100 is generated, model parameters and optimization variables generated at a training time point closest to a corresponding time point may be provided to the training device 100.

Alternatively, the storage device 200 may store training data used when optimization variables or model parameters are generated. The storage device 200 may delete the training data or store some of the training data after performing optimization computations.

For example, as in the example illustrated in <EX 2>, optimization variables and model parameters generated at training time points 3 and 13 may be stored in the storage device 200. Training data provided from the training device 100 at the training time points 1, 2, 3, 11, 12 and 13 may be stored in the storage device 200. Although only some of optimization variables and model parameters are stored, because training data is stored, some optimization variables and model parameters may be restored using the training data.

For example, by using model parameters and optimization variables generated at the training time point 3 and training data used in corresponding optimization computations, model parameters and optimization variables generated at the training time point 2 or the training time point 1 may be restored. When a request for a corresponding time point is generated, the storage device 200 may restore model parameters and optimization variables using stored training data, and then, may provide the restored model parameters and optimization variables to the training device 100.

In addition, in accordance with the present disclosure, the storage device 200 may store and provide model parameters and optimization variables at each training time point.

For example, as in <EX 3>, the storage device 200 may store model parameters and optimization variables generated by optimization computations at each training time point. When a request from the training device 100 is generated, the storage device 200 may provide at least some of the stored model parameters and optimization variables to the training device 100. The storage device 200 may convert data set to the second unit data size to conform to the first unit data size, and then, may provide the converted data to the training device 100.

Moreover, as in <EX 4>, all training data used at respective training time points may be stored, and only some of model parameters and optimization variables may be stored.

For example, model parameters and optimization variables according to optimization computations performed at training time points 1, 6, 11 and 16 may be stored in the storage device 200. Training data used in optimization computations at all training time points may be stored in the storage device 200.

When a restoration request by the training device 100 is generated, model parameters and optimization variables of a corresponding time point may be restored using training data and some model parameters and optimization variables stored in the storage device 200. A restoration operation may be performed in a forward direction according to the order of time or in a backward direction opposite to the order of time.

Restoration according to a request from the training device 100 may be easily performed while reducing the amount of data stored in the storage device 200.

In this way, in the computing system that performs training of an artificial intelligence model, by performing optimization computations and progressing a checkpoint operation in a device other than the training device 100, efficiency according to computation operations and data movement may be improved and the operational performance of the computing system may be enhanced. The structure of the computing system that performs training may be configured in various ways.

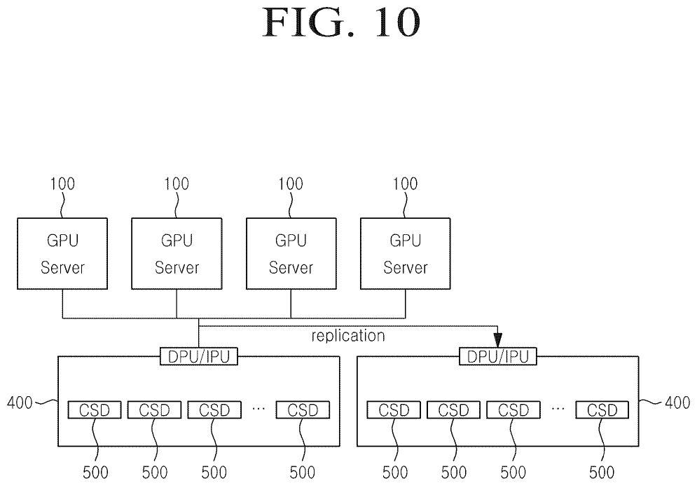

FIG. 10 is a diagram illustrating another example of the schematic structure of the computing system according to the embodiments of the present disclosure.

Referring to FIG. 10, the computing system may include a plurality of training devices 100. The training device 100 may be configured with a server that includes a graphics processing unit.

The computing system may include a plurality of data processing devices 400. The data processing device 400 may be, for example, a data processing unit (DPU) or an infrastructure processing unit (IPU), but is not limited thereto. The data processing device 400 may be a device including a processor that is designed to better perform a specific operation for data processing.

In this case, the training device 100 may be referred to as a first processing unit, and the data processing device 400 may be referred to as a second processing unit.

The data processing device 400 may include a plurality of computational storage devices (CSDs) 500. The computational storage device 500 may mean the storage device 200 described above.

The plurality of training devices 100 may remotely communicate with the plurality of data processing devices 400. Each of the plurality of training devices 100 may receive model parameters stored in the computational storage device 500 included in the data processing device 400, and may perform some computations among computations for training.

The plurality of training devices 100 may perform computations for each layer among computations for training, and may provide training data generated according to the computations to the data processing device 400.

When receiving the training data, the data processing device 400 may perform optimization computations using the computational storage device 500 and generate or update model parameters and optimization variables. The process may include replication in which multiple copies of the data may be transferred between the plurality of training devices 100 and the data processing device 400. The data processing device 400 may provide the generated or updated model parameters to the training device 100 so that next training is performed. The data processing device 400 may store at least some of the model parameters and optimization variables in the computational storage device 500 and use them when restoration is required.

In this way, the structure of the computing system that performs computations for training of an artificial intelligence model may be configured in various ways. By performing some of the computations for training by the storage device 200 or the data processing device 400 including the computational storage device 500, the computation load of the training device 100 may be reduced.

In addition, by reducing data movement according to a checkpoint operation performed during a computation process, the efficiency of data movement during training may be improved, and the operational performance of the computing system that performs training of an artificial intelligence model may be improved.

Embodiments of the present disclosure may perform computations for training of an artificial intelligence model in a storage device located outside a training device, thereby reducing the computation load of the training device, and may reduce the amount of data moved between the training device and the storage device in the process of performing training, thereby improving the operational performance of a computing system that performs training.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A computing system comprising:
a first processing unit configured to perform training computations based on first model parameters to generate training data; and
a computational storage device configured to
receive the training data from the first processing unit,
perform second optimization computations based on the first model parameters, the training data, and first optimization variables, the first optimization variables being generated by first optimization computations for generating the first model parameters, and
provide second model parameters generated by the second optimization computations to the first processing unit.

2. The computing system according to claim 1, wherein the computational storage device is configured to:
generate second optimization variables by the second optimization computations; and
store at least some of the second optimization variables and the second model parameters.

3. The computing system according to claim 1, wherein the computational storage device is configured to:
store the training data;
generate restored model parameters based on the training data when receiving a restoration request from the first processing unit; and
provide the restored model parameters to the first processing unit.

4. The computing system according to claim 1, wherein the computational storage device is configured to:
store a) first training data generated at a first training time point when the first model parameters are generated, and b) second training data generated at a second training time point when the second model parameters are generated; and
store c) the first model parameters and the first optimization variables corresponding to the first training data, or d) the second model parameters and the second optimization variables corresponding to the second training data.

5. The computing system according to claim 4, wherein the computational storage device is configured to:
store the first training data, the first model parameters, and the first optimization variables; and
restore the second model parameters and the second optimization variables based on the second training data, the first model parameters, and the first optimization variables.

6. The computing system according to claim 4, wherein the computational storage device is configured to:
store the second training data, the second model parameters, and the second optimization variables; and
restore the first model parameters and the first optimization variables based on the first training data, the second model parameters, and the second optimization variables, the second training time point following the first training time point.

7. The computing system according to claim 1, wherein the computational storage device is configured to delete, when the second model parameters are generated, the training data used to generate the second model parameters.

8. The computing system according to claim 1, wherein:
the training data is generated according to a first unit data size; and
the second model parameters are generated according to a second unit data size larger than the first unit data size.

9. The computing system according to claim 1, wherein the computational storage device is configured to:
receive, from the first processing unit, the training data generated according to a first unit data size;
convert the training data according to a second unit data size larger than the first unit data size; and
perform the second optimization computations based on the converted training data.

10. The computing system according to claim 9, wherein the computational storage device is configured to:
convert the second model parameters generated based on the second unit data size by the second optimization computations according to the first unit data size; and
provide the converted second model parameters to the first processing unit.

11. The computing system according to claim 1, wherein the first processing unit is configured to receive the first model parameters from the computational storage device.

12. The computing system according to claim 1, wherein the first processing unit is configured to:
perform forward training computations based on the first model parameters to generate active data; and
perform backward training computations based on the first model parameters and the active data to generate the training data.

13. The computing system according to claim 1, wherein the first processing unit is configured to:
perform the training computations based on the second model parameters when receiving the second model parameters; and
provide the training data generated by the training computations to the computational storage device.

14. The computing system according to claim 1, further comprising a second processing unit configured to:
store the training data received from the first processing unit and provide the training data to the computational storage device; and
store the second model parameters received from the computational storage device and provide the second model parameters to the first processing unit.

15. A computing system comprising:
a first processing unit configured to perform training computations using first model parameters, to generate training data; and
a second processing unit configured to
perform optimization computations based on the training data,
provide second model parameters generated by the optimization computations to the first processing unit, and
store at least some of the training data and the second model parameters.

16. The computing system according to claim 15, wherein the second processing unit is configured to:
store first training data used for generating the first model parameters and second training data used for generating the second model parameters; and
store only some of the first model parameters and the second model parameters.

17. The computing system according to claim 16, wherein, according to a request from the first processing unit, the second processing unit is configured to:
restore the second model parameters based on the first model parameters and the first training data, and provide the restored second model parameters to the first processing unit; or
restore the first model parameters using the second model parameters and the second training data, and provide the restored first model parameters to the first processing unit.

18. The computing system according to claim 15, wherein:
the first model parameters provided to the first processing unit are generated according to a first unit data size; and
the second model parameters provided to the second processing unit are generated according to a second unit data size larger than the first unit data size.

19. A computational storage device comprising:
a memory configured to store first model parameters and first optimization variables; and
a controller configured to
provide the first model parameters to an external device,
receive training data generated by training computations performed by the external device based on the first model parameters,
perform optimization computations based on the first model parameters, the training data, and the first optimization variables, and
provide second model parameters generated by the optimization computations to the external device.

20. The computational storage device according to claim 19, wherein the controller is further configured to:
store the training data in the memory;
generate restored model parameters using the training data according to a request from the external device; and
provide the restored model parameters to the external device.
